(19) United States
(12) Patent Application Publication
(10) Pub. No.: US 2025/0384308 A1
(43) Pub. Date: Dec. 18, 2025

(54) INFORMATION PROCESSING APPARATUS

(71) Applicant: NEC Corporation, Tokyo (JP)

(72) Inventor: Yuzuru OKAJIMA, Tokyo (JP)

(73) Assignee: NEC Corporation, Tokyo (JP)

(21) Appl. No.: 19/226,396

(22) Filed: Jun. 3, 2025

(30) Foreign Application Priority Data
Jun. 12, 2024 (JP) 2024-094984

(51) Int. Cl. G06N 5/022

(52) U.S. Cl. CPC G06N 5/022

(57) ABSTRACT

An information processing apparatus of the present disclosure includes: a generating unit that generates, based on case data each including a plurality of sets of explanatory variables and objective variables, a plurality of scenarios each including a pair of a condition of the explanatory variable and a prediction value based on the objective variable of the case data falling under the condition; and a determining unit that determines a combination of the scenarios, based on an evaluation value calculated in accordance with whether the case data falls under the condition of the scenario to be combined and a number of the scenarios to be combined.

### INCORPORATION BY REFERENCE

This application is based upon and claims the benefit of priority from Japanese patent application No. 2024-094984, filed on Jun. 12, 2024, the disclosure of which is incorporated herein in its entirety by reference.

### TECHNICAL FIELD

The present disclosure relates to an information processing apparatus.

### BACKGROUND ART

Making a prediction on input data using a machine learning model is practiced in various fields. For example, in Patent Literature 1, prediction of future time-series data from multivariate time-series data using a prediction model is practiced. Then, such a prediction using a prediction model can be used by a company to develop and execute a business plan, and in this case, scenario planning is useful. Scenario planning is to make a plan for future assuming a plurality of future scenarios in which various uncertain factors that may have an impact on the business change. At this time, as an example of the scenario, a rule-based model composed of a condition and a result can be used.

### CITATION LIST

### Patent Literature

[Patent Literature 1] Japanese Translation of PCT International Application Publication No. JP-T 2023-550959

### SUMMARY OF INVENTION

### Technical Problem

However, in performing scenario planning, there is a problem that it is difficult to create a small number of scenarios that can cover possible future events. That is to say, in scenario planning, in the case of making it possible to cover possible future events with a high probability, scenarios increase excessively and there is a fear that a human cannot understand the contents of the scenarios. As a result, it is difficult to create an appropriate scenario for predicting a case.

Accordingly, an object of the present disclosure is to solve the abovementioned problem that it is difficult to create an appropriate scenario for performing a prediction on a case.

### Solution to Problem

An information processing apparatus as an aspect of the present disclosure includes: a generating unit configured to generate, based on case data each including a plurality of sets of explanatory variables and objective variables, a plurality of scenarios each including a pair of a condition of the explanatory variable and a prediction value based on the objective variable of the case data falling under the condition; and a determining unit configured to determine a combination of the scenarios, based on an evaluation value calculated in accordance with whether the case data falls under the condition of the scenario to be combined and a number of the scenarios to be combined.

Further, an information processing method as an aspect of the present disclosure includes: generating, based on case data each including a plurality of sets of explanatory variables and objective variables, a plurality of scenarios each including a pair of a condition of the explanatory variable and a prediction value based on the objective variable of the case data falling under the condition; and determining a combination of the scenarios, based on an evaluation value calculated in accordance with whether the case data falls under the condition of the scenario to be combined and a number of the scenarios to be combined.

Further, a program as an aspect of the present disclosure includes instructions for causing a computer to execute processes to: generate, based on case data each including a plurality of sets of explanatory variables and objective variables, a plurality of scenarios each including a pair of a condition of the explanatory variable and a prediction value based on the objective variable of the case data falling under the condition; and determine a combination of the scenarios, based on an evaluation value calculated in accordance with whether the case data falls under the condition of the scenario to be combined and a number of the scenarios to be combined.

### Advantageous Effects of Invention

With the configurations as described above, the present disclosure can create an appropriate scenario for performing a prediction on a case.

### BRIEF DESCRIPTION OF DRAWINGS

FIG. 1 is a block diagram showing an example of a configuration of an information processing apparatus according to the present disclosure.

FIG. 2 is a diagram showing an example of a state of processing by the information processing apparatus according to the present disclosure.

FIG. 3 is a diagram showing an example of a state of processing by the information processing apparatus according to the present disclosure.

FIG. 4 is a diagram showing an example of a state of processing by the information processing apparatus according to the present disclosure.

FIG. 5 is a diagram showing an example of a state of processing by the information processing apparatus according to the present disclosure.

FIG. 6 is a diagram showing an example of a state of processing by the information processing apparatus according to the present disclosure.

FIG. 7 is a flowchart showing an example of processing operation of the information processing apparatus according to the present disclosure.

FIG. 8 is a flowchart showing an example of processing operation of the information processing apparatus according to the present disclosure.

FIG. 9 is a flowchart showing an example of processing operation of the information processing apparatus according to the present disclosure.

FIG. 10 is a block diagram showing an example of a hardware configuration of an information processing apparatus according to the present disclosure.

FIG. 11 is a block diagram showing an example of a configuration of the information processing apparatus according to the present disclosure.

### EXAMPLE EMBODIMENTS

### First Example Embodiment

A first example embodiment of the present disclosure will be described with reference to the drawings. The drawings may be related to any example embodiment.

An information processing apparatus 10 in this example embodiment creates a scenario that can be applied when a company performs scenario planning to make a business plan. A business plan made by a company is, for example, a plan according to a demand prediction on goods and services in response to an environmental change. Examples are to make a manufacturing plan by predicting beverage sales volume in response to a change in environment such as temperature, and to make an oil refining plan by predicting a demand on oil in response to a change in crude oil price (raw material price). Other examples are to make a manufacture plan by predicting the quality of a product in response to a change in environment such as a manufacture condition, to make a transaction plan by predicting an appropriate amount of transactions in response to a changes of a financial transaction pattern and the like, and even to make a treatment plan by predicting the condition of a patient in response to a change of patient's physical measurement value and the like.

In this example embodiment, as an example, assuming that a company engaged in the business of bicycle rental makes a plan for the number of bicycles to place by predicting the demanded quantity of bicycle rental in response to a change in environment such as temperature, a scenario that can be applied when making such a business plan will be created. However, the scenario created in the present disclosure may be applicable to any type of business.

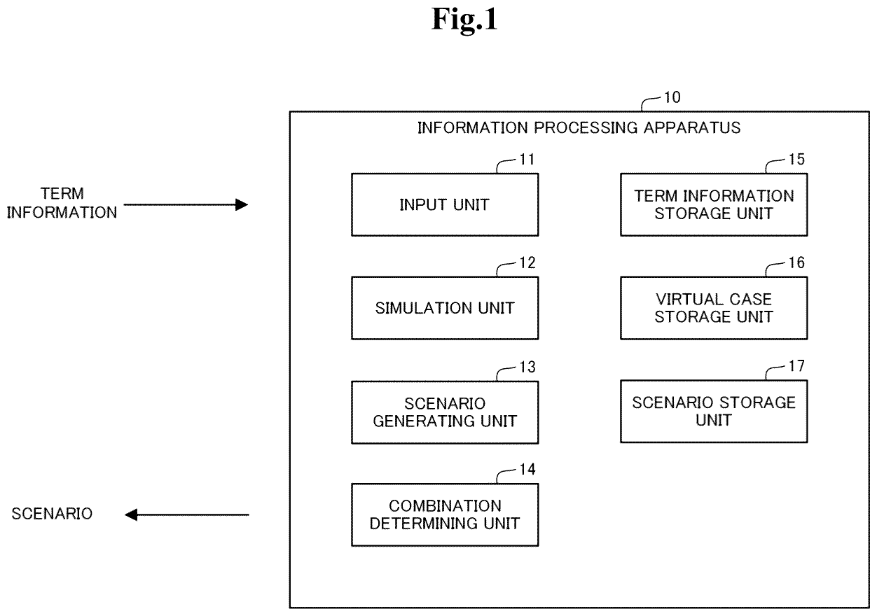

The information processing apparatus 10 is configured with one or a plurality of information processing apparatuses each including an arithmetic logic unit and a memory unit. Then, as shown in FIG. 1, the information processing apparatus 10 includes an input unit 11, a simulation unit 12, a scenario generating unit 13, and a combination determining unit 14. The respective functions of the input unit 11, the simulation unit 12, the scenario generating unit 13, and the combination determining unit 14 can be implemented by execution of a program for implementing the respective functions stored in the memory unit by the arithmetic logic unit. Moreover, the information processing apparatus 10 includes a term information storage unit 15, a virtual case storage unit 16, and a scenario storage unit 17. The term information storage unit 15, the virtual case storage unit 16, and the scenario storage unit 17 are configured with the memory unit. The function and operation of each of the components will be described below.

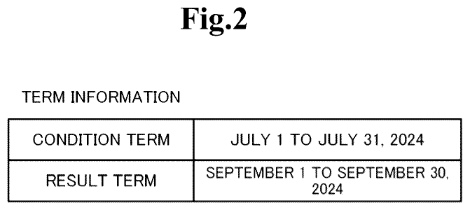

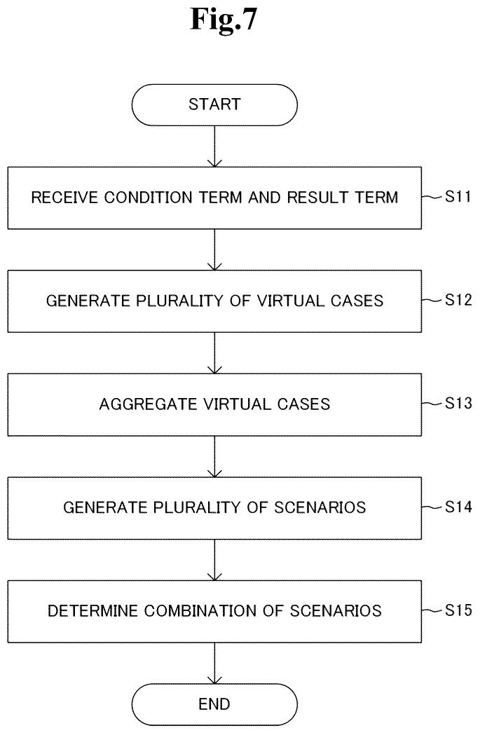

The input unit 11 receives input of “condition term” and “result term” as term information, and stores it into the term information storage unit 15 (step S11 of FIG. 7). The condition term (first period) is a period to determine whether a case meets a condition. The result term (second period) is a period to evaluate what the result will be of the case that meets the condition. The condition term and the result term may overlap, and may be the same period. FIG. 2 shows an example of the input. In this example, “July 2024” is designated as the condition term, and “September 2024” as the result term. By distinguishing the condition term and the result term, it is facilitated to change a future action plan from the observed information. For example, by creating in advance a scenario for predicting the sales (demand) of products in September based on the temperature in July, it is possible to determine which scenario is applicable at the time of observing the temperature in July, which enables decision making such as changing the manufacturing plan (supply) of the products in time for sales in September.

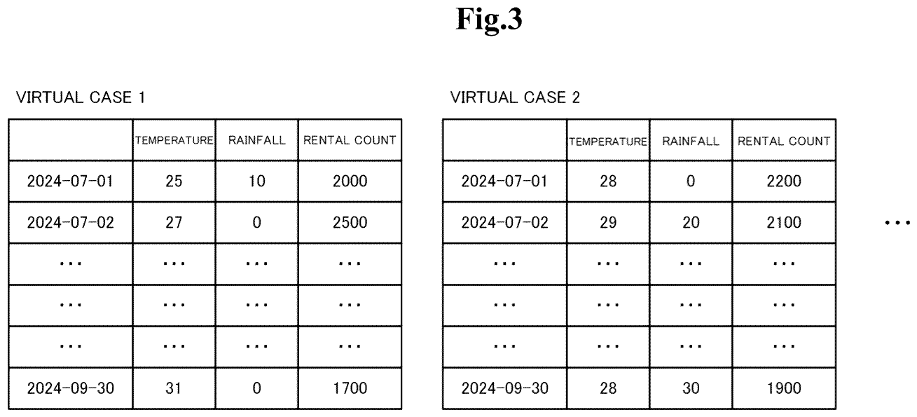

The simulation unit 12 generates a plurality of virtual cases (case data), which are multivariate time-series data, using sampling from a probability model, and stores into the virtual case storage unit 16 (step S12 of FIG. 7). An example of the virtual cases generated by the simulation unit 12 is shown in FIG. 3. In this example, multivariate time-series data composed of a set of three explanatory variables “temperature”, “rainfall” and “rental count” and an objective variable “bicycle rental count” for each of the days of a time-series is generated as a virtual case. A “virtual case 1” represents data obtained in the first trial, and a “virtual case 2” represents data obtained in the second trial. Although only two virtual cases are shown in this view, more virtual cases, for example, 1,000 virtual cases are generated for practical purposes.

The simulation unit 12 generates a virtual case using a probability model created in advance. As the probability model used by the simulation unit 12, any model can be used as long as it is a model that can probabilistically generate multivariate time-series data by machine learning of learning data composed of an explanatory variable and an objective variable prepared in advance. A vector autoregression model (VAR model) can be used as the probability model, for example. Expressing a VAR model of order p by an expression, Formula 1 shown below is obtained.

$${y}_{t} = c + {A}_{1} {y}_{t - 1} + {A}_{2} {y}_{t - 2} + … + {A}_{p} {y}_{t - p} + {e}_{t} \qquad [ Formula 1 ]$$

If the number of variables is k, yₜ is a vector of length k that is composed of the values at time t of the k variables. In the expression, c is a constant vector of length k, Aᵢ is a constant matrix of k×k, and eₜ is a vector of length k that is referred to as an error term and represents noise added at time t. If there is no error term eₜ, then yₜ is uniquely determined from a past value. However, when the error term eₜ is present and the error is determined based on a probability distribution (e.g., multivariate normal distribution), even during the same period, different time-series data are obtained every time the trial is performed repeatedly. Such time-series data is used as a virtual case.

Although the above VAR model does not consider seasonality, it is possible to perform more realistic simulation by using a VAR model improved in consideration of seasonality, and the like.

As the parameter of the probability model used by the simulation unit 12, it is possible to use one adjusted by machine learning based on actually observed past data. In the example of FIG. 3, “rental count” represents the rental count of bicycles. Since the tendency of the rental count to decrease when the temperature is too high or too low or when the rainfall is too much and the rental count to increase when the temperature is not too high or not too low and the rainfall is little is machine-learned in the probability model from the past data, a realistic virtual case can be generated.

The simulation unit 12 generates a virtual case in such a manner as to include data of at least the condition term and the result term. In the example shown in FIG. 3, data for three months from July to September is generated. The virtual case is not necessarily limited to being generated by the simulation unit 12, and may be stored in the virtual case storage unit 16 upon receiving input of a previously generated virtual case. In addition, the virtual case may be data measured from an actual case.

The scenario generating unit 13 (generating unit) aggregates the generated virtual cases by unit used for scenario generation. This process is selectable, and may be omitted. For example, the scenario generating unit 13 may aggregate the virtual cases generated on a daily basis as described above, on a monthly basis. Consequently, it becomes possible to, while performing the simulation of the virtual cases described above precisely on a daily basis, describe a scenario shown to humans on a monthly basis that is easier to grasp. When aggregating virtual cases, the scenario generating unit 13 may perform special aggregation and conversion other than averaging and summing in order to raise interpretability.

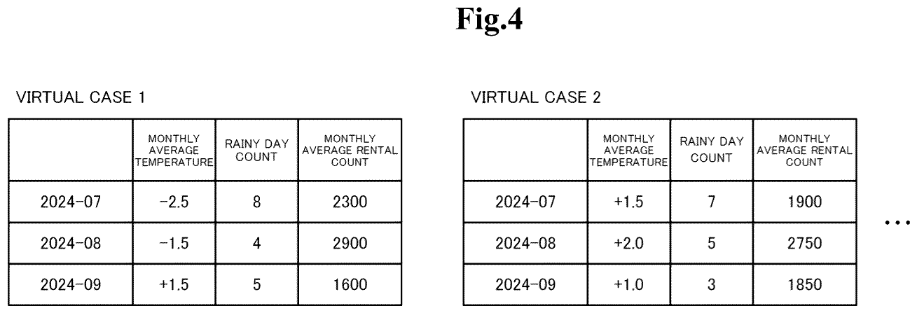

FIG. 4 shows an example of the virtual cases after aggregation by the scenario generating unit 13. In this example, the virtual cases generated by the simulation unit 12 on a daily basis are aggregated on a monthly basis. At this time, the scenario generating unit 13 aggregates after converting temperature into monthly average temperature, which is specifically obtained by subtracting the average temperature for a typical year from the monthly average value of the temperatures. Consequently, it is facilitated to grasp whether it is higher or lower than in a typical year. Moreover, the scenario generating unit 13 counts the number of days when the rainfall is larger than 0, thereby aggregating after converting the rainfall into the number of rainy days per month. Meanwhile, the scenario generating unit 13 may aggregate the virtual cases by any method.

The scenario generating unit 13 generates a plurality of scenarios each including a pair of “condition” in the condition term and “prediction value” calculated from a value taken in the result term by a virtual case meeting the condition, and stores them into the scenario storage unit 17 (step S14 of FIG. 7).

When generating a scenario, the scenario generating unit 13 distinguishes an explanatory variable and an objective variable of a virtual case. An explanatory variable is a variable used for generating a condition, and an objective variable is a variable used for calculating a prediction. Here, as shown in FIG. 4, “monthly average temperature” and “rainy day count” obtained by aggregating virtual cases are explanatory variables, and “rental count” is an objective variable. However, which variable is an explanatory variable and which variable is an objective variable when the scenario generating unit 13 generates a scenario may be fixedly set or designated by the user from outside.

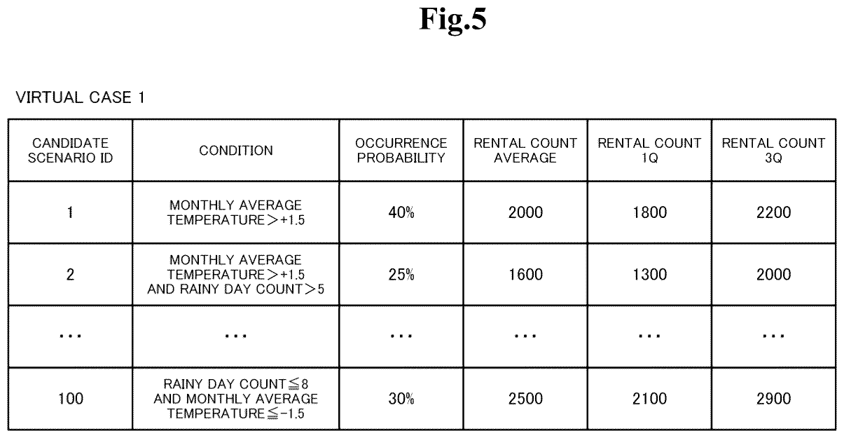

FIG. 5 shows an example of a scenario generated by the scenario generating unit 13. In this example, 100 scenarios are generated. A column “candidate scenario ID” indicates a serial number assigned to each of the scenarios. A column “condition” indicates a condition in a condition term for determining whether a certain case meets the scenario. A column “occurrence probability” indicates the percentage of the virtual cases meeting the condition in the condition term among the generated virtual cases. Columns “rental count average”, “rental count 1Q” and “rental count 3Q are prediction values with respect to the objective variable. The prediction values are values obtained by aggregating the values of the objective variable in the result term with respect to the virtual case meeting the condition in the condition term. The terms 1Q and 3Q refers to the first and third quartiles, respectively.

As a specific example, a case of creating a scenario z from the virtual case shown in FIG. 4 will be described. For example, in “virtual case 1”, “monthly average temperature (−2.5)” and “rainy day count (8)” that are the explanatory variables of “July” that is the condition term fall under “condition” of “scenario z”, “prediction value” of “scenario z” is calculated using “rental count (1600)” that is the objective variable of “September” that is the result term in “virtual case 1”.

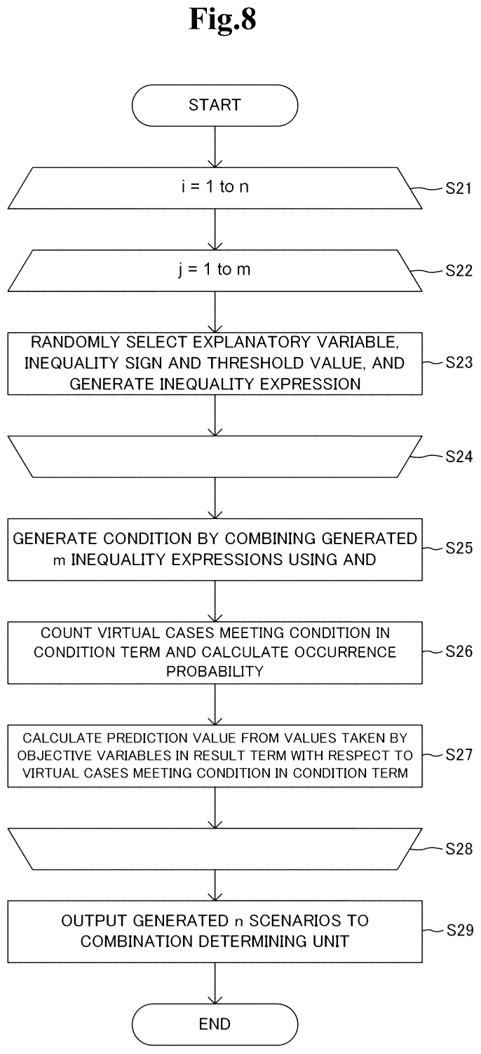

FIG. 8 shows a flowchart when the scenario generating unit 13 generates a scenario. Here, the number of scenarios to be generated is n, and the number of inequalities included in one condition is m.

First, the scenario generating unit 13 starts a loop in order to generate n scenarios (step S21 of FIG. 8). Moreover, the scenario generating unit 13 starts a loop in order to generate m inequalities (step S22 of FIG. 8).

Subsequently, the scenario generating unit 13 randomly selects an explanatory variable, an inequality sign, and a threshold value, thereby generating an inequality expression (step S23 of FIG. 8). For example, one explanatory variable is randomly selected from “monthly average temperature” and “rainy day count”. Moreover, one inequality sign is randomly selected from “<=” and “>”. Furthermore, a threshold value is randomly selected. For example, the threshold value may be selected uniformly at random between the maximum value and the minimum value of an explanatory variable included in a virtual case. Consequently, one inequality expression like “monthly average temperature>+3.5” can be generated. Then, the scenario generating unit 13 terminates the inequality expression generation loop (step S24 of FIG. 8). By the termination of the loop, m inequality expressions can be obtained. Although the explanatory variable, the inequality sign, and the threshold value are randomly selected above, an inequality expression may be generated by selecting in accordance with a preset rule.

Subsequently, the scenario generating unit 13 obtains “condition” by combining the generated m inequality expressions using “AND” (step S25 of FIG. 8). For example, “condition” like “monthly average temperature>+3.5 AND rainy day count<=5” can be obtained. In a case where no virtual case falls under a condition obtained by combining all the inequality expression using AND, some of the inequality expressions may be excluded.

Subsequently, the scenario generating unit 13 calculates “occurrence probability” by counting the virtual cases meeting “condition” in the condition term (step S26 of FIG. 8). For example, if 350 virtual cases out of 1,000 virtual cases meet the condition, the occurrence probability is 35%.

Subsequently, the scenario generating unit 13 calculates “prediction value” by aggregating values taken by the objective variable in the result term with respect to the virtual cases meeting “condition” in the condition term (step S27 of FIG. 8). For example, the average value or quartile of the objective variables in the result terms of all the virtual cases meeting “condition” can be used as the prediction value.

The scenario generating unit 13 terminates the scenario generation loop (step S28 of FIG. 8). By the termination of the loop, n scenarios can be obtained. Then, the scenario generating unit 13 outputs the generated n scenarios to the combination determining unit 14 (step S29 of FIG. 8). As an example, the scenario generating unit 13 generates 100 scenarios. However, the number of scenarios to be generated is not limited to the abovementioned number.

The combination determining unit 14 (determining unit) determines a combination of a plurality of scenarios from among the scenarios generated as described above (step S15 of FIG. 7). At this time, the combination determining unit 14 determines a combination of scenarios based on an evaluation value calculated in accordance with whether a virtual case falls under the condition of a scenario to be combined and the number of scenarios to be combined. To be specific, as the abovementioned evaluation value, the combination determining unit 14 calculates a value corresponding to a percentage that a virtual case falls under the condition of a scenario, determines a combination of scenarios in such a manner that the percentage is high and the number of scenarios included in the combination is small, and outputs it as a scenario set.

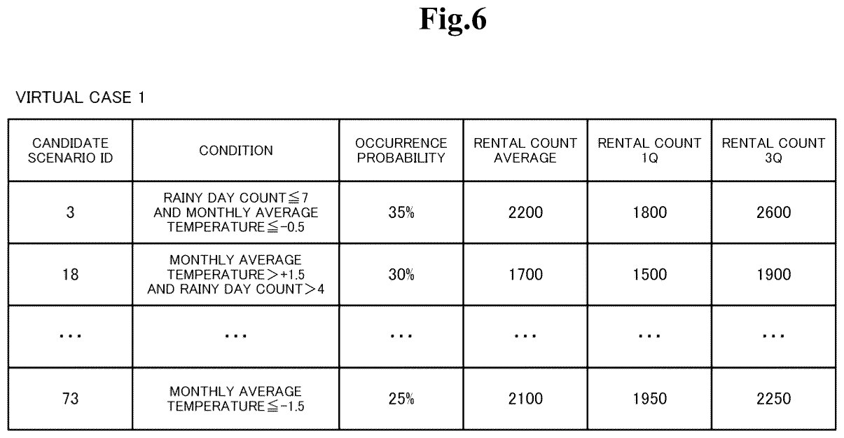

Here, an example of the scenario set output by the combination determining unit 14 is shown in FIG. 6. In this example, the combination determining unit 14 selects only some scenarios with candidate scenario ID=3, 18, . . . , 73 from among 100 scenarios generated by the scenario generating unit 13, and outputs a scenario set composed of a combination of these scenarios.

The determination of the combination of scenarios by the combination determining unit 14 can be formulated as a combinatorial optimization problem. Two examples of an objective function that can be used as an objective function for a combinatorial optimization problem are shown below.

A first example of the objective function will be described. A set of virtual cases is X, a set of scenarios generated by the scenario generating unit 13 is So, and a set of scenarios determined by the combination determining unit 14 is S. At this time, the first example of the objective function can be expressed as Formula 2 below.

$${max}_{S ⊂ {S}_{o}} R ( S ) - λ \vert S \vert \qquad [ Formula 2 ]$$

$$where$$

$$R ( S ) = \vert {⋃}_{s ∈ S} \{ x ∈ X \vert P ( x , s ) \} \vert / \vert X \vert$$

Here, P(x,s) is a logical expression that is true when a virtual case x falls under the condition of a scenario s in a condition term, R(S) indicates the rate of virtual cases meeting the condition of the scenario included in the combination, |S| is the number of scenarios included in the combination, and A is a hyper parameter for adjusting whether to focus on R(S) or |S|. The first example of the objective function takes a higher value as the number of scenarios included in the combination of scenarios is small and the rate of virtual cases falling under the conditions of the scenarios included in the combination is high. Consequently, a combination of scenarios that can be obtained by maximizing the objective function R(S)−λ|S| is determined.

A second example of the objective function for optimization will be given. The second example is different in further considering the error of the prediction. As preparation, a set Sub(x,S) of scenarios that are included in the scenario set S and the virtual case x falls under is defined by Formula 3 below.

$$Sub ( x , S ) = \{ s ∈ S \vert P ( x , s ) \} \qquad [ Formula 3 ]$$

Furthermore, an error E(x,S) between the virtual case x and the scenario set S is defined as Formula 4 below.

$$E ( x , S ) = \{ \begin{matrix}{min}_{s ∈ Sub ( x , S )} {‖ {y}_{x} - {y}_{s} ‖}^{2} , & Sub ( x , S ) \neq ∅ \\ {‖ {y}_{x} - {y}_{m} ‖}^{2} , & Sub ( x , S ) = ∅\end{matrix} \qquad [ Formula 4 ]$$

In Formula 4, yₓ is the value of an objective variable in a result term of a predetermined virtual case x, and yₛ is the average of the objective variables in the result term of the virtual cases falling under the scenario s (comparison value), that is, yₛ is the prediction value of the scenario which the predetermined virtual case x falls under, yₘ is the average of the objective variables in the result term of all the virtual cases (comparison value), ∥yₓ−yₛ∥² represents the squared error between the objective variable of each of the predetermined virtual cases and the prediction (comparison value) in the scenario and represents the degree to which the scenario s could not predict what the objective variable of the predetermined virtual case x would have been. When Sub(x,S)≠0, E(S) can be said to be the result of, for each case, finding a scenario with the smallest error from among scenarios that the case falls under and averaging the error. However, when Sub(x,S)=0, that is, in a case where there is no scenario falling under a predetermined virtual case x, ∥yₓ−yₘ∥² is used as the error with yₓ instead. Since yₘ is the average of the objective variables on all the virtual cases where the selection has not been made by the condition, it is a prediction with low accuracy as a prediction, and ∥yₓ−yₘ∥² generally takes a large value. That is to say, in a case where a scenario which a predetermined virtual case falls under is not included in the scenario set S, the error takes a larger value than in a case where that scenario is included in the scenario set S.

Using the above definition, the second example of the objective function is defined as Formula 5 below.

$${max}_{s ⊂ {s}_{o}} - \frac{1}{\vert X \vert} {\sum }_{x ∈ X} E ( x , S ) - λ \vert S \vert \qquad [ Formula 5 ]$$

By maximizing this objective function, the scenario set S is selected such that the average of errors E(x,S) with respect to the respective virtual cases x included by the virtual case X is small and the number of scenarios included by the scenario set S is small. Consequently, in a case where a scenario which a virtual case falls under is not included by the scenario set S, the error becomes large, so that a scenario set which a virtual case falls under as much as possible is selected.

The second example of the objective function is the same as the first example in that the objective function takes a higher value as the number of scenarios included by a combination is smaller and the rate of virtual cases falling under the condition of the scenario included by the combination is higher. However, the second example is different in further considering the error of the prediction. Consequently, in selection of a combination of scenarios, a scenario such that not only a virtual case meets a condition, but also the prediction of the scenario is closer. This will increase the likelihood of a combination of close-to-prediction scenarios for possible future events.

The combination determining unit 14 finds the scenario set S that maximizes the objective function. Most simply, the combination determining unit repeatedly performs a process of randomly selecting the subset S of the set S₀ and calculating the objective function multiple times, and outputs the set S with the highest objective function.

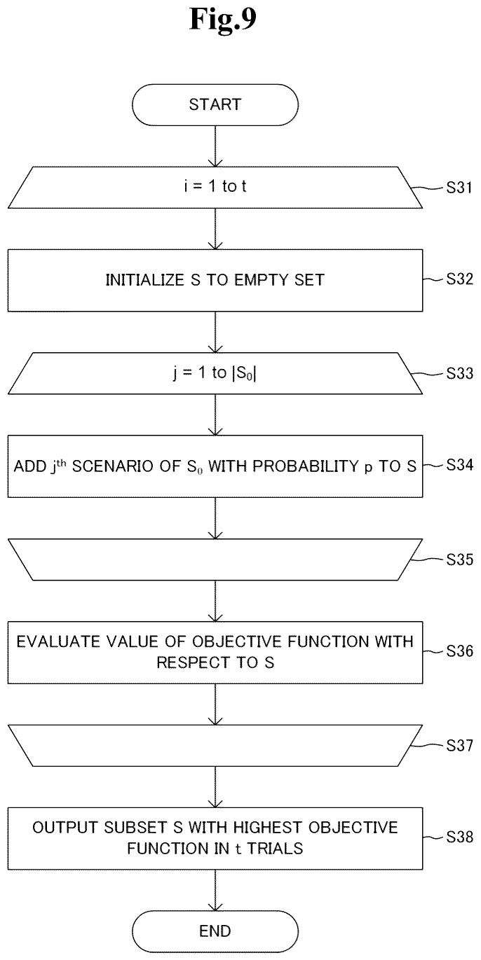

Here, an example of a flowchart of the combination determination process is shown in FIG. 9. The combination determining unit 14 repeats t times adding a scenario included by the set S₀ with probability p and generating the subset S of scenarios (steps S31 to S37 of FIG. 9). At this time, the combination determining unit 14 evaluates the value of the objective function of the subset S of scenarios (step S36 of FIG. 9). Then, the combination determining unit 14 outputs the subset S of scenarios with the highest value of the objective function (step S38 of FIG. 9). At this time, t and p are hyperparameters set in advance.

The combination determining unit 14 may maximize the objective function using an optimization method different from the abovementioned method. For example, the combination determining unit may determine a combination that maximizes the objective function by formulating to a mathematical optimization problem such as an integer programming problem or a maximum satisfiability problem (Max-SAT) and using a mathematical optimization solver.

The number of scenarios included by a combination may not be explicitly included by the objective function. That is to say, Formula 2 and Formula 5 may not include the term −λ|S|. In that case, the number of scenarios included by a combination may be given as a constraint in searching for a solution, instead of being explicitly included by the objective function. For example, in a case where the number of scenarios included by a combination is fixed to 10, the combination determining unit 14 may output a combination such that the value of the objective function becomes the highest, among the candidates for the combination in which the number of scenarios is 10. A candidate for the combination in which the number of scenarios is 10 can be obtained by, for example, non-recovery random sampling of 10 scenarios from the set S₀. The number of scenarios included by the combination set as the constraint is not limited to a fixed value as described above, and may be the upper limit value or a value within a predetermined range, and in that case, the combination determining unit 14 may determine a combination including a number of scenarios that does not exceed the upper limit value or the range.

### Second Example Embodiment

Next, a second example embodiment of the present disclosure will be described with reference to the drawings. This example embodiment shows the overview of the information processing apparatus and so forth described in the above example embodiment. The drawings may be related to any of the example embodiments.

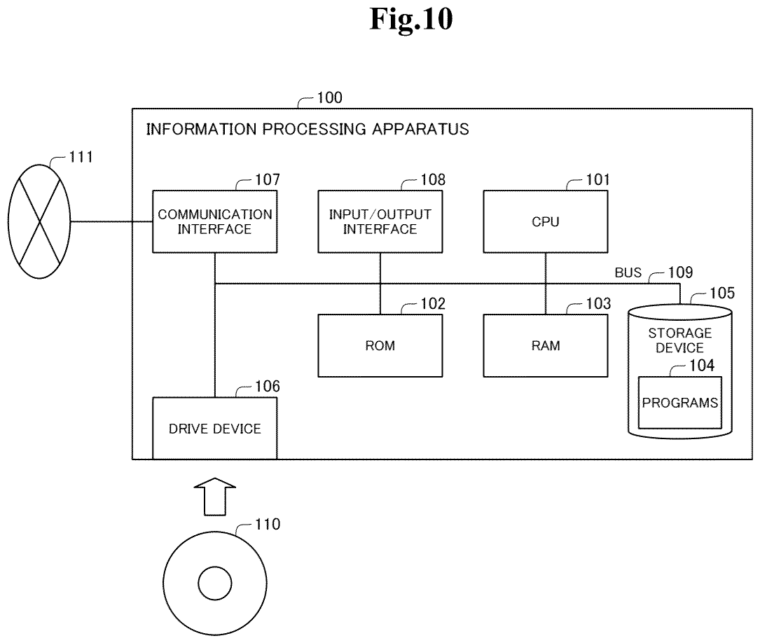

First, a hardware configuration of an information processing apparatus 100 in the present disclosure will be described. The information processing apparatus 100 is configured with a general information processing apparatus, and as an example, as shown in FIG. 10, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 10 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

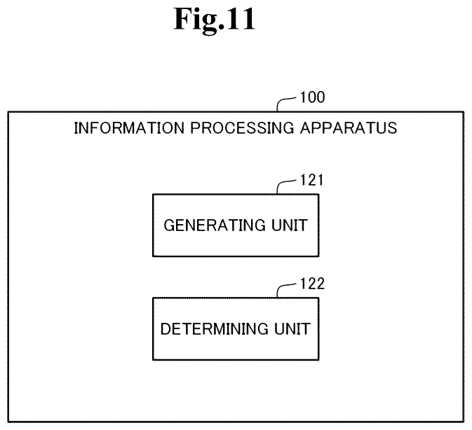

Then, the information processing apparatus 100 can construct and include a generating unit 121 and a determining unit 122 shown in FIG. 11 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the generating unit 121 and the determining unit 122 may be constructed using dedicated electronic circuits for implementing such means.

The generating unit 121 generates, based on case data including a plurality of sets of explanatory variables and objective variables, a plurality of scenarios each including a pair of a condition of the explanatory variable and a prediction value based on the objective variable of the case data falling under the condition. The determining unit 122 determines a combination of the scenarios based on an evaluation value calculated in accordance with whether the case data falls under the conditions of the scenarios to be combined and the number of the scenarios to be combined.

With the configuration as described above, the present disclosure can determine a combination of a small number of scenarios that can cover a number of case data, and create an appropriate scenario for performing a prediction on a case.

At least one or more functions of the functions of the generating unit 121 and the determining unit 122 described above may be executed by an information processing apparatus installed and connected anywhere on the network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### Supplementary Notes

The whole or part of the example embodiments disclosed above can be described as the following supplementary notes. Hereinafter, the overview of configurations of an information processing apparatus, an information processing method, and a program in the present disclosure will be described. However, the present disclosure is not limited to the configurations described in the following supplementary notes.

All or some of the configurations described in Supplementary Notes 2 to 8 dependent on Supplementary Note 1 described below and the functions by such configurations may be dependent on other Supplementary Notes 9 and 16 by the same dependence as Supplementary Notes 2 to 8. Furthermore, not limited to Supplementary Notes 1, 9, or 16, within the scope of the example embodiments described above, all or some of the configurations described as supplementary notes and functions by such configurations may be dependent on hardware, software, various recording means for recording software, or system.

### Supplementary Note 1

An information processing apparatus comprising:
a generating unit configured to generate, based on case data each including a plurality of sets of explanatory variables and objective variables, a plurality of scenarios each including a pair of a condition of the explanatory variable and a prediction value based on the objective variable of the case data falling under the condition; and
a determining unit configured to determine a combination of the scenarios, based on an evaluation value calculated in accordance with whether the case data falls under the condition of the scenario to be combined and a number of the scenarios to be combined.

### Supplementary Note 2

The information processing apparatus according to supplementary note 1, wherein
the determining unit is configured to calculate, as the evaluation value, a rate at which the case data falls under the condition of the scenario to be combined, and determine the combination of the scenarios based on the rate and the number of the scenarios to be combined.

### Supplementary Note 3

The information processing apparatus according to supplementary note 2, wherein
the determining unit is configured to determine the combination of the scenarios in such a manner that the rate that the case data falls under the condition of the scenario to be combined is higher and the number of the scenarios to be combined is smaller.

### Supplementary Note 4

The information processing apparatus according to supplementary note 1, wherein
the determining unit is configured to calculate, as the evaluation value, an error between a value of the objective variable of a predetermined piece of the case data and a comparison value based on the objective variable of the case data calculated in accordance with whether the predetermined case data falls under the condition of the scenario to be combined, and determine the combination of the scenarios based on the error and the number of the scenarios to be combined.

### Supplementary Note 5

The information processing apparatus according to supplementary note 4, wherein
the determining unit is configured to, with respect to the predetermined case data that does not fall under the condition of the scenario to be combined, calculate the error in such a manner as to be a larger value than in a case where the predetermined case data falling under the condition, and determine the combination of the scenarios in such a manner that the error is smaller and the number of the scenarios is smaller.

### Supplementary Note 6

The information processing apparatus according to supplementary note 4, wherein
the determining unit is configured to, with respect to the predetermined case data that falls under the condition of the scenario to be combined, set the prediction value of the scenario as the comparison value and, with respect to the predetermined case data that does not fall under the condition of the scenario to be combined, set a value based on the objective variables of all the case data as the comparison value, calculate the error, and determine the combination of the scenarios in such a manner that the error is smaller and the number of the scenarios is smaller.

### Supplementary Note 7

The information processing apparatus according to supplementary note 1, wherein
the generating unit is configured to generate the scenario including a pair of the condition of the explanatory variable in a preset first term of the case data that is time-series data and the prediction value based on the objective variable in a preset second term of the case data falling under the condition.

### Supplementary Note 8

The information processing apparatus according to supplementary note 7, wherein
the second term is a later term in a time series than the first term.

### Supplementary Note 9

An information processing method comprising:
generating, based on case data each including a plurality of sets of explanatory variables and objective variables, a plurality of scenarios each including a pair of a condition of the explanatory variable and a prediction value based on the objective variable of the case data falling under the condition; and
determining a combination of the scenarios, based on an evaluation value calculated in accordance with whether the case data falls under the condition of the scenario to be combined and a number of the scenarios to be combined.

### Supplementary Note 10

The information processing method according to supplementary note 9, comprising
calculating, as the evaluation value, a rate at which the case data falls under the condition of the scenario to be combined, and determining the combination of the scenarios based on the rate and the number of the scenarios to be combined.

### Supplementary Note 11

The information processing method according to supplementary note 10, comprising
determining the combination of the scenarios in such a manner that the rate that the case data falls under the condition of the scenario to be combined is higher and the number of the scenarios to be combined is smaller.

### Supplementary Note 12

The information processing method according to supplementary note 9, comprising
calculating, as the evaluation value, an error between a value of the objective variable of a predetermined piece of the case data and a comparison value based on the objective variable of the case data calculated in accordance with whether the predetermined case data falls under the condition of the scenario to be combined, and determining the combination of the scenarios based on the error and the number of the scenarios to be combined.

### Supplementary Note 13

The information processing method according to supplementary note 12, comprising
with respect to the predetermined case data that does not fall under the condition of the scenario to be combined, calculating the error in such a manner as to be a larger value than in a case where the predetermined case data falling under the condition, and determining the combination of the scenarios in such a manner that the error is smaller and the number of the scenarios is smaller.

### Supplementary Note 14

The information processing method according to supplementary note 12, comprising
with respect to the predetermined case data that falls under the condition of the scenario to be combined, setting the prediction value of the scenario as the comparison value and, with respect to the predetermined case data that does not fall under the condition of the scenario to be combined, setting a value based on the objective variables of all the case data as the comparison value, calculating the error, and determining the combination of the scenarios in such a manner that the error is smaller and the number of the scenarios is smaller.

### Supplementary Note 15

The information processing method according to supplementary note 9, comprising
generating the scenario including a pair of the condition of the explanatory variable in a preset first term of the case data that is time-series data and the prediction value based on the objective variable in a preset second term of the case data falling under the condition.

### Supplementary Note 16

A program comprising instructions for causing a computer to execute processes to:
generate, based on case data each including a plurality of sets of explanatory variables and objective variables, a plurality of scenarios each including a pair of a condition of the explanatory variable and a prediction value based on the objective variable of the case data falling under the condition; and
determine a combination of the scenarios, based on an evaluation value calculated in accordance with whether the case data falls under the condition of the scenario to be combined and a number of the scenarios to be combined.

### REFERENCE SIGNS LIST

10 information processing apparatus
11 input unit
12 simulation unit
13 scenario generating unit
14 combination determining unit
15 term information storage unit
16 virtual case storage unit
17 scenario storage unit
100 information processing apparatus
101 CPU
102 ROM
103 RAM
104 programs
105 storage device
106 drive device
107 communication interface
108 input/output interface
109 bus
110 storage medium
111 communication network
121 generating unit
122 determining unit

1. An information processing apparatus comprising:
at least one memory storing processing instructions; and
at least one processor configured to execute the processing instructions to:
generate, based on case data each including a plurality of sets of explanatory variables and objective variables, a plurality of scenarios each including a pair of a condition of the explanatory variable and a prediction value based on the objective variable of the case data falling under the condition; and
determine a combination of the scenarios, based on an evaluation value calculated in accordance with whether the case data falls under the condition of the scenario to be combined and a number of the scenarios to be combined.

2. The information processing apparatus according to claim 1, wherein the at least one processor is configured to execute the processing instructions to
calculate, as the evaluation value, a rate at which the case data falls under the condition of the scenario to be combined, and determine the combination of the scenarios based on the rate and the number of the scenarios to be combined.

3. The information processing apparatus according to claim 2, wherein the at least one processor is configured to execute the processing instructions to
determine the combination of the scenarios in such a manner that the rate that the case data falls under the condition of the scenario to be combined is higher and the number of the scenarios to be combined is smaller.

4. The information processing apparatus according to claim 1, wherein the at least one processor is configured to execute the processing instructions to
calculate, as the evaluation value, an error between a value of the objective variable of a predetermined piece of the case data and a comparison value based on the objective variable of the case data calculated in accordance with whether the predetermined case data falls under the condition of the scenario to be combined, and determine the combination of the scenarios based on the error and the number of the scenarios to be combined.

5. The information processing apparatus according to claim 4, wherein the at least one processor is configured to execute the processing instructions to
with respect to the predetermined case data that does not fall under the condition of the scenario to be combined, calculate the error in such a manner as to be a larger value than in a case where the predetermined case data falling under the condition, and determine the combination of the scenarios in such a manner that the error is smaller and the number of the scenarios is smaller.

6. The information processing apparatus according to claim 4, wherein the at least one processor is configured to execute the processing instructions to
with respect to the predetermined case data that falls under the condition of the scenario to be combined, set the prediction value of the scenario as the comparison value and, with respect to the predetermined case data that does not fall under the condition of the scenario to be combined, set a value based on the objective variables of all the case data as the comparison value, calculate the error, and determine the combination of the scenarios in such a manner that the error is smaller and the number of the scenarios is smaller.

7. The information processing apparatus according to claim 1, wherein the at least one processor is configured to execute the processing instructions to
generate the scenario including a pair of the condition of the explanatory variable in a preset first term of the case data that is time-series data and the prediction value based on the objective variable in a preset second term of the case data falling under the condition.

8. The information processing apparatus according to claim 7, wherein the at least one processor is configured to execute the processing instructions to
the second term is a later term in a time series than the first term.

9. An information processing method comprising:
generating, based on case data each including a plurality of sets of explanatory variables and objective variables, a plurality of scenarios each including a pair of a condition of the explanatory variable and a prediction value based on the objective variable of the case data falling under the condition; and
determining a combination of the scenarios, based on an evaluation value calculated in accordance with whether the case data falls under the condition of the scenario to be combined and a number of the scenarios to be combined.

10. The information processing method according to claim 9, comprising
calculating, as the evaluation value, a rate at which the case data falls under the condition of the scenario to be combined, and determining the combination of the scenarios based on the rate and the number of the scenarios to be combined.

11. The information processing method according to claim 10, comprising
determining the combination of the scenarios in such a manner that the rate that the case data falls under the condition of the scenario to be combined is higher and the number of the scenarios to be combined is smaller.

12. The information processing method according to claim 9, comprising
calculating, as the evaluation value, an error between a value of the objective variable of a predetermined piece of the case data and a comparison value based on the objective variable of the case data calculated in accordance with whether the predetermined case data falls under the condition of the scenario to be combined, and determining the combination of the scenarios based on the error and the number of the scenarios to be combined.

13. The information processing method according to claim 12, comprising
with respect to the predetermined case data that does not fall under the condition of the scenario to be combined, calculating the error in such a manner as to be a larger value than in a case where the predetermined case data falling under the condition, and determining the combination of the scenarios in such a manner that the error is smaller and the number of the scenarios is smaller.

14. The information processing method according to claim 12, comprising
with respect to the predetermined case data that falls under the condition of the scenario to be combined, setting the prediction value of the scenario as the comparison value and, with respect to the predetermined case data that does not fall under the condition of the scenario to be combined, setting a value based on the objective variables of all the case data as the comparison value, calculating the error, and determining the combination of the scenarios in such a manner that the error is smaller and the number of the scenarios is smaller.

15. The information processing method according to claim 9, comprising
generating the scenario including a pair of the condition of the explanatory variable in a preset first term of the case data that is time-series data and the prediction value based on the objective variable in a preset second term of the case data falling under the condition.

16. A non-transitory computer-readable storage medium storing a program, the program comprising instructions for causing a computer to execute processes to:
generate, based on case data each including a plurality of sets of explanatory variables and objective variables, a plurality of scenarios each including a pair of a condition of the explanatory variable and a prediction value based on the objective variable of the case data falling under the condition; and
determine a combination of the scenarios, based on an evaluation value calculated in accordance with whether the case data falls under the condition of the scenario to be combined and a number of the scenarios to be combined.
